(19) United States
(12) Patent Application Publication
(10) Pub. No.: US 2013/0045368 A1
(43) Pub. Date: Feb. 21, 2013

(54) PLASMA DISPLAY PANEL

(71) Applicants: Yugo Takeda, Osaka (JP); Hideki Oku, Kyoto (JP); Hiroyuki Isse, Osaka (JP)

(72) Inventors: Yugo Takeda, Osaka (JP); Hideki Oku, Kyoto (JP); Hiroyuki Isse, Osaka (JP)

(21) Appl. No.: 13/452,495

(22) Filed: Apr. 20, 2012

(30) Foreign Application Priority Data
Apr. 22, 2011 (JP) 2011-095775

(51) Int. Cl. B32B 3/02; B32B 3/30

(52) U.S. Cl. 428/172; 428/192

(57) ABSTRACT

A PDP includes a front plate, a rear plate, and a sealing layer. The rear plate includes a display region between the rear plate and the front plate, and a non-display region around the display region. The rear plate includes a terminal area located in the non-display region, and a base dielectric layer. The sealing layer is laid in the non-display region, and has plural bead members. The base dielectric layer covers the display region and a portion of the terminal area without sticking outward from the sealing layer. The sealing layer is partially located between a region of the base dielectric layer that covers the terminal area, and the front plate. An edge of a region of the base dielectric layer that covers the terminal area is covered with the sealing layer, and is present at substantially the same position where an edge of the front plate is present.

### BACKGROUND

1. Technical Field

The present disclosed technique relates to a plasma display panel used in a display device or the like.

2. Description of the Related Art

Plasma display panels (hereinafter referred to as PDPs) are each composed of a front plate and a rear plate. The front plate and the rear plate are bonded to each other, for sealing therebetween, at the respective peripheries thereof with a sealing material. A discharge space is formed between the front plate and the rear plate.

As a spacer (for the space), use may be made of a member which has a higher melting point than a glass component contained in the sealing material (see Unexamined Japanese Patent Publication No. 2001-236896).

### SUMMARY

The PDP disclosed in the present specification includes a front plate, a rear plate, and a sealing layer for bonding the front plate and the rear plate. The rear plate includes a display region for generating electric discharge between the rear plate and the front plate, and a non-display region arranged around the display region. The rear plate further includes a terminal area located in the non-display region, and a base dielectric layer. The sealing layer is laid in the non-display region, and has plural bead members. The base dielectric layer covers the display region and a portion of the terminal area without sticking outward from the sealing layer. The sealing layer is partially located between a region of the base dielectric layer that covers the terminal area, and the front plate. An edge of the region of the base dielectric layer that covers the terminal area is covered with the sealing layer, and the edge lies at substantially the same position as an edge of the front plate.

### BRIEF DESCRIPTION OF DRAWINGS

FIG. 1 is a schematic perspective view illustrating the structure of a PDP according to an embodiment of the invention;

FIG. 2 is a schematic front view illustrating the structure of the PDP according to the embodiment;

FIG. 3 is a partial view of a cross section taken on the line 3-3 in FIG. 2;

FIG. 4 is a flowchart showing a method for producing the PDP according to the embodiment;

FIG. 5 is a view illustrating one step for the production of its rear plate;

FIG. 6 is a view illustrating another step for the production of the rear plate;

FIG. 7 is a view illustrating still another step for the production of the rear plate;

FIG. 8 is a graph showing an example of a temperature profile used for the production of the PDP according to the embodiment; and

FIG. 9 is a view of a cross section taken on the line 9-9 in FIG. 2.

### DETAILED DESCRIPTION

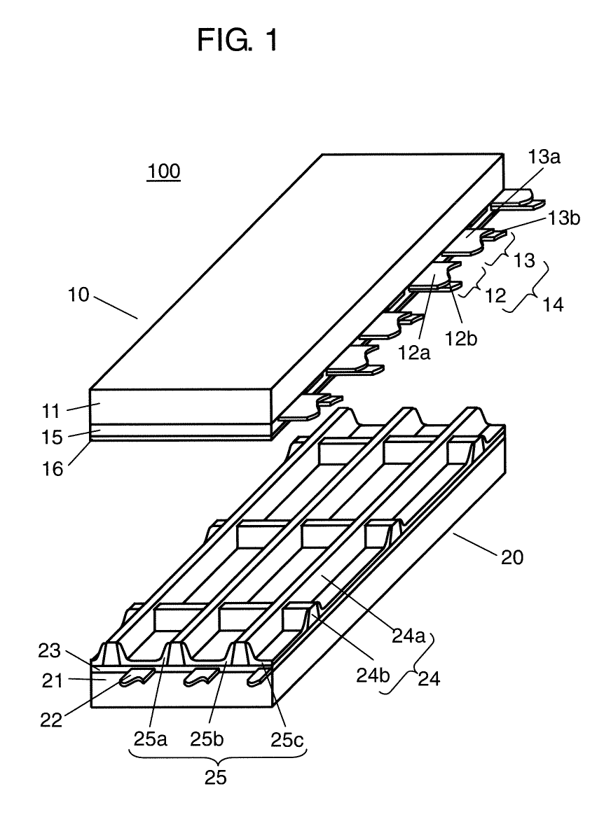

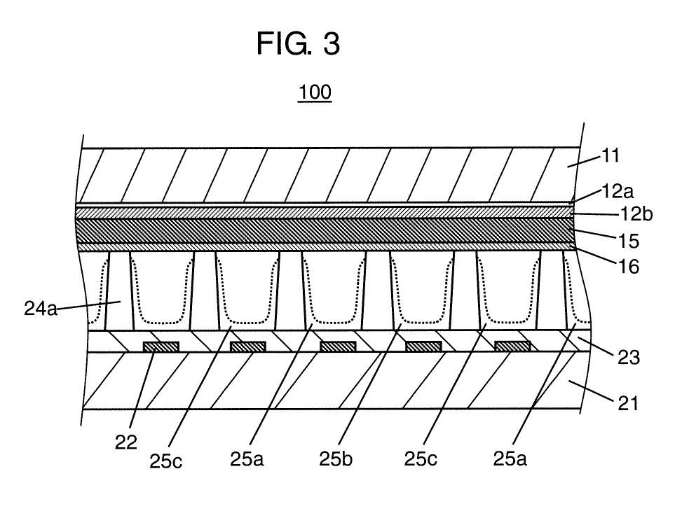

PDP 100 in FIGS. 1 to 3, is a surface discharge AC-PDP. As illustrated in these figures, front plate 10 and rear plate 20 are arranged to be opposed to each other. Furthermore, a discharge gas containing xenon (Xe) is sealed up in a discharge space therebetween to give a pressure of 55 kPa to 80 kPa.

As illustrated in FIGS. 1 to 3, front plate 10 includes rectangular front glass substrate 11. Plural display electrodes 14 are laid on a surface of front glass substrate 11. Display electrodes 14 are each arranged in parallel with long sides of front glass substrate 11. Each display electrode 14 has single scan electrode 12 and single sustain electrode 13. The interval between scan electrode 12 and sustain electrode 13 is a display gap. Scan electrode 12 includes transparent electrode 12a laid on front glass substrate 11, and bus electrode 12b stacked on transparent electrode 12a. Sustain electrode 13 includes transparent electrode 13a laid on front glass substrate 11, and bus electrode 13b stacked on transparent electrode 13a. Each of transparent electrodes 12a and 13a contains an electro-conductive metal oxide, such as indium tin oxide (ITO), tin oxide (SnO₂), or zinc oxide (ZnO). Bus electrodes 12b and 13b each contain silver (Ag) in order to gain a good electro-conductivity. Front plate 10 includes dielectric layer 15 for covering display electrodes 14. Dielectric layer 15 is made of a bismuth oxide (Bi₂O₃) based low-melting-point glass, a zinc oxide (ZnO) based low-melting-point glass, or some other glasses. Front plate 10 includes protective layer 16 for covering dielectric layer 15.

Protective layer 16 is required to have a function of holding electric charges for generating (electric) discharge, and a function of emitting secondary electrons for sustained discharge. When the charge-holding performance is improved, the voltage to be applied (to the PDP) is decreased. When the number of the emitted secondary electrons is increased, the driving voltage for generating the sustained discharge is decreased. Protective layer 16 in the embodiment contains an alkaline earth metal oxide, such as magnesium oxide (MgO).

As illustrated in FIGS. 1 to 3, rear plate 20 includes rectangular glass substrate 21. Plural address electrodes 22 are laid on a surface of rear glass substrate 21. Address electrodes 22 are each arranged in parallel with short sides of rear glass substrate 21. In other words, address electrodes 22 are each arranged orthogonally to display electrodes 14. Address electrodes 22 contain silver (Ag) in order to gain a good electro-conductivity. The film thickness of address electrodes 22 is preferably from 1.0 μm to 2.5 μm inclusive.

Rear plate 20 includes base dielectric layer 23 for covering plural address electrodes 22. Base dielectric layer 23 is, for example, a layer of a bismuth oxide (Bi₂O₃) based low-melting-point glass. In detail, base dielectric layer 23 contains a glass component, and a filler.

The glass component contains, for example, bismuth oxide (Bi₂O₃). The glass component may further contain zinc oxide (ZnO). The glass component may further contain at least one selected from the group consisting of calcium oxide (CaO), strontium oxide (SrO), and barium oxide (BaO). The glass component may further contain at least one selected from the group consisting of molybdenum oxide (MoO₃), tungsten oxide (WO₃), cerium oxide (CeO₂), manganese oxide (MnO₂), copper oxide (CuO), chromium oxide (Cr₂O₃), cobalt oxide (Co₂O₃), vanadium oxide (V₂O₅), and antimony oxide (Sb₂O₃).

The filler may contain at least one selected from the group consisting of aluminum oxide (Al₂O₃), silicon oxide (SiO₂), titanium oxide (TiO₂), zirconium oxide (ZrO₂), MgO, and cordierite. TiO₂ reflects visible rays to contribute to an improvement in the emission efficiency of PDP 100.

Barrier ribs 24 for dividing the discharge space are laid on base dielectric layer 23. Barrier ribs 24 include longitudinal barrier ribs 24a arranged in parallel with address electrodes 22, and transverse barrier ribs 24b arranged in parallel with display electrodes 14. Any one of longitudinal barrier ribs 24a is located between one of address electrodes 22, and address electrode 22 adjacent thereto. In short, barrier ribs 24 are formed into a lattice form.

Barrier ribs 24 contain a low-melting-point glass, and others. In detail, barrier ribs 24 contain a glass component and a filler. The proportion of the glass component to the total of the glass component and the filler is from 70% by weight to 90% by weight inclusive. The glass component contains Bi₂O₃ in a proportion of 20% by weight to 40% by weight. The glass component may contain at least one selected from the group consisting of CaO, SrO, and BaO in a proportion of 0.5% by weight to 12% by weight. The glass component may further contain at least one selected from the group consisting of MoO₃, WO₃, CeO₂, MnO₂, CuO, Cr₂O₃, Co₂O₃, V₂O₅, and Sb₂O₃ in a proportion of 0.1% by weight to 7% by weight.

The filler contains at least one selected from the group consisting of Al₂O₃, SiO₂, TiO₂, ZrO₂, MgO, and cordierite.

When PDP 100 is a PDP adapted to a high definition television (Full High Vision Television) having a rectangular screen having a diagonal line length of 42 inches, the height of barrier ribs 24 is from 0.1 mm to 0.15 mm, and the pitch between adjacent ones of longitudinal barrier ribs 24a is 0.15 mm. The height of longitudinal barrier ribs 24a may be equivalent to that of transverse barrier ribs 24b.

Rear plate 20 includes phosphor layer 25. Phosphor layer 25 is laid on the front surface of base dielectric layer 23, and side surfaces of barrier ribs 24. Phosphor layer 25 includes red phosphor layer 25a for emitting red light, green phosphor layer 25b for emitting green light, and blue phosphor layer 25c for emitting blue light. About red phosphor layer 25a, green phosphor layer 25b, and blue phosphor layer 25c, respective pieces thereof are formed by turns to interpose one of longitudinal barrier ribs 24a between any adjacent two these pieces. Red phosphor layer 25a, green phosphor layer 25b, and blue phosphor layer 25c each has a light emission center that is excited by ultraviolet rays.

A red phosphor used in red phosphor layer 25a is, for example, a Eu³⁺ activated red phosphor having a main light emission peak in the range of wavelengths of 610 nm or more, and less than 630 nm. The red phosphor is specifically particles of Y₂O₃:Eu³⁺ (YOX phosphor), (Y, Gd)₂O₃:Eu³⁺ (YGX phosphor), Y(P, V)O₄:Eu³⁺ (YPV phosphor) or some other phosphor.

The green phosphor used in green phosphor layer 25b is, for example, a phosphor which contains a Mn³⁺ activated short-afterglow-period green phosphor having a light emission peak in the range of wavelengths of 500 nm or more and less than 560 nm and an afterglow period longer than 2 msec and shorter than 5 msec, and a Ce³⁺ activated green phosphor or Eu³⁺ activated green phosphor having a light emission peak in the range of wavelengths of 490 nm or more and less than 560 nm. The green phosphor is specifically particles of Zn₂SiO₄:Mn³⁺ (ZSM phosphor), Y₃Al₅O₁₂:Ce³⁺ (YAG phosphor), or some other phosphor.

A blue phosphor used in blue phosphor layer 25c is, for example, a Eu³⁺ activated blue phosphor having a main light emission peak in the range of wavelengths of 420 nm or more and less than 500 nm. Any blue phosphor containing Eu³⁺ as an activating agent emits light on the basis of electron energy transition from 4f⁶5d¹ to 4f⁷. Thus, blue light emission having an afterglow period shorter than 1 msec can be realized. The blue phosphor is specifically particles of BaMgAl₁₀O₁₇:Eu³⁺ (BAM phosphor), CaMgSiO₆:Eu³⁺ (CMS phosphor), Sr₃MgSi₂O₈:Eu³⁺ (SMS phosphor), or some other phosphor.

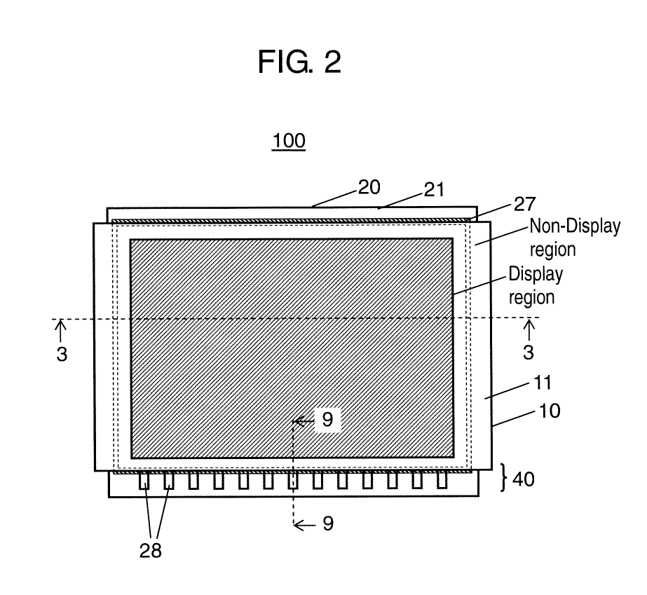

As illustrated in FIG. 1, front plate 10 and rear plate 20 are arranged to be opposed to each other in such a manner that display electrodes 14 cross address electrodes 22. As illustrated in FIG. 2, front plate 10 and rear plate 20 are bonded to each other, for sealing therebetween, at the respective peripheries thereof through sealing layer 27. Rear plate 20 has address-electrode-side interconnect portions 28 connected to address electrodes 22. Address-electrode-side interconnect portions 28 are electrically connected to a circuit board not illustrated. In rear plate 20, a region where address-electrode-side interconnect portions 28 are located is terminal area 40. Details of sealing layer 27 will be described later.

As illustrated in FIG. 1, a discharge space is formed between front plate 10 and rear plate 20 bonded to each other. A discharge gas containing, for example, xenon (Xe) is sealed into the discharge space to give a pressure of about 60 kPa. The discharge space is divided into plural sections by barrier ribs 24. Discharge cells are formed at respective portions where display electrodes 14 cross address electrodes 22.

As illustrated in FIG. 2, in PDP 100, a region where the discharge cells are located is a display region. Around the display region, a non-display region is located. When electric discharge is generated in each of the discharge cells which have individual color phosphor layers 25a, 25b and 25c, the individual color phosphor layers 25a, 25b and 25c emit respective light rays. Thus, PDP 100 can display a color image. The structure of PDP 100 is not limited to the structure described just above, and may be a structure wherein the form of barrier ribs 24 is a stripe form.

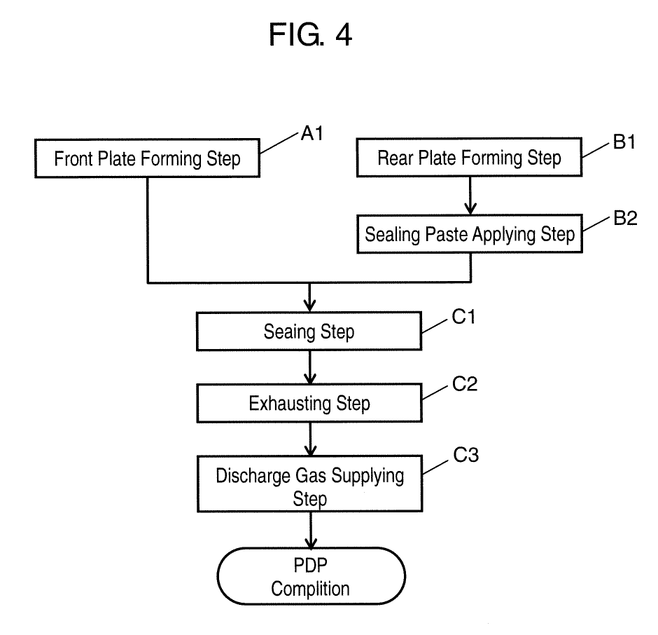

As illustrated in FIG. 4, a method for producing PDP 100 according to the present embodiment has front plate forming step A1, rear plate forming step B1, sealing paste applying step B2, sealing step C1, exhausting step C2, and discharge gas supplying step C3.

In front plate forming step A1, display electrodes 14, dielectric layer 15 and protective layer 16 are formed on front glass substrate 11.

Photolithography is used to form scan electrodes 12 and sustain electrodes 13 on front glass substrate 11. First, transparent electrodes 12a and 13a made of indium tin oxide (ITO) or the like, are formed.

Next, bus electrodes 12b and 13b are formed. The material of bus electrodes 12b and 13b may be an electrode paste containing silver (Ag), a glass frit for bonding silver to each other, a photosensitive resin, a solvent, and others. First, screen printing or another printing manner is used to apply the electrode paste onto front glass substrate 11 on which transparent electrodes 12a and 13a are formed. Next, in a drying oven, the electrode paste is dried at a temperature ranging, for example, from 100° C. to 250° C. By the drying, the solvent is removed from the electron paste. Next, the electrode paste is exposed to light through a photomask wherein, for example, a pattern of plural rectangles is formed.

Next, the electrode paste is developed. When the used photosensitive resin is of a positive type, the exposed portions are removed. The remnant of the electrode paste is an electrode pattern. Lastly, in a baking oven, the electrode pattern is baked at a temperature ranging, for example, from 400° C. to 550° C. By the baking, the photosensitive resin is removed from the electrode pattern. By the baking, the glass frit in the electrode pattern is melted. The melted glass fit is again vitrified after the baking. Through these steps, bus electrodes 12b and 13b are formed.

Besides the above-mentioned method, use may be made of a method of forming a metal film by sputtering, vapor deposition or some other technique, and then patterning the film, or some other method.

The material of dielectric layer 15 may be a dielectric paste containing a dielectric glass frit, a resin, a solvent and others. First, die coating or another coating manner is used to apply the dielectric paste into a predetermined thickness on front glass substrate 11. The applied dielectric paste covers scan electrodes 12 and sustain electrodes 13. Next, in a drying oven, the dielectric paste is dried at a temperature ranging, for example, from 100° C. to 250° C. By the drying, the solvent is removed from the dielectric paste. Lastly, in a baking oven, the dielectric paste is baked at a temperature ranging, for example, from 400° C. to 550° C. By the baking, the resin is removed from the dielectric paste. By the baking, the dielectric glass frit is melted. The melted glass frit is again vitrified after the baking. Through these steps, dielectric layer 15 is formed.

Besides the above-mentioned manner, screen printing, spin coating, or some other manner may be used. Without using any dielectric paste, a film that is to be dielectric layer 15 may be formed by CVD (chemical vapor deposition) or the like.

Protective layer 16 is formed by use of, for example, an EB (electron beam) vapor deposition equipment. When protective layer 16 contains MgO and CaO, the material of protective layer 16 is MgO pellets made of MgO monocrystal and CaO pellets made of CaO monocrystal. In short, it is advisable to select pellets in accordance with the composition of protective layer 16. The MgO pellets or the CaO pellets may further contain, as impurities, aluminum (Al), silicon (Si), and others.

First, electron beams are radiated to the MgO pellets and the CaO pellets set in a film-depositing chamber of the EB vapor deposition equipment. The front surfaces of the MgO and CaO pellets that receive the energy of the electron beams are vaporized. MgO vaporized from the MgO pellets, and CaO vaporized from the CaO pellets adhere onto front glass substrate 11 that is shifting in the film-depositing chamber. In more detail, MgO and CaO adhere, through a mask where a region corresponding to a region that is to be a display region is opened, onto dielectric layer 15. Front glass substrate 11 is heated to about 300° C. by means of a heater. The pressure in the film-depositing chamber is reduced to about 10⁻⁴ Pa, and then oxygen gas is supplied to the chamber to keep the pressure to give an oxygen partial pressure of about 3×10⁻² Pa. The film thickness of protective layer 16 is adjusted into a predetermined range through the strength of the electron beams, the pressure in the film-depositing chamber, the shift speed of front glass substrate 11, and others.

In rear plate forming step B1, address electrodes 22, base dielectric layer 23, barrier ribs 24, and phosphor layer 25 are formed on rear glass substrate 21.

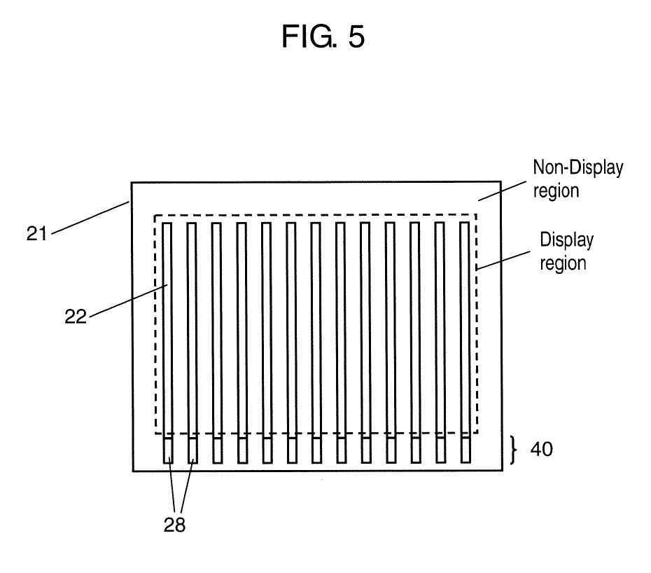

As illustrated in FIG. 5, photolithography is used to form address electrodes 22 and address-electrode-side interconnect portions 28 on rear glass substrate 21. The region where address-electrode-side interconnect portions 28 are formed is terminal area 40. The material of address electrodes 22 may be an address electrode paste containing a glass frit for bonding silver (Ag) particles as an electro-conductor to each other, a photosensitive resin, a solvent, and others. The content by percentage of the silver (Ag) particles in the address electrode paste is from 70% by weight to 90% by weight. The content by percentage of the glass component therein is from 1% by weight to 15% by weight. The content by percentage of the photosensitive resin and the solvent therein is from 8% by weight to 15% by weight. The glass component includes at least bismuth oxide (Bi₂O₃) in a proportion of 20% by weight to 50% by weight. The glass component is formulated to render the softening point of the bonding glass a temperature higher than 550° C.

First, screen printing or another printing manner is used to apply the address electrode paste into a predetermined thickness onto rear glass substrate 21. Next, in a drying oven, the address electrode paste is dried at a temperature ranging, for example, from 100° C. to 250° C. By the drying, the solvent is removed from the address electrode paste. The address electrode paste is exposed to light through a photomask wherein, for example, a pattern of plural rectangles is formed. Next, the address electrode paste is developed. When the used photosensitive resin is of a positive type, the exposed regions are removed. The remnant of the address electrode paste is an address electrode pattern. Lastly, in a baking oven, the address electrode pattern is baked at a temperature ranging, for example, from 550° C. to 570° C. By the baking, the photosensitive resin is removed from the address electrode pattern. By the baking, the glass frit in the address electrode pattern is melted. The melted glass frit is again vitrified after the baking. Through these steps, address electrodes 22 are formed.

Besides the above-mentioned method, use may be made of, for example, a method of forming a metal film by sputtering, vapor deposition or some other technique, and then patterning the film.

Next, base dielectric layer 23 is formed. The material of base dielectric layer 23 may be a base dielectric paste containing a glass frit, a filler, a resin, a solvent and others. The base dielectric paste may be a paste into which the following are incorporated: 25% by weight to 35% by weight of a glass component; 25% by weight to 35% by weight of a filler; 10% by weight to 20% by weight of a binder; and 20% by weight to 30% by weight of a solvent. The glass component does not substantially include any lead component. The glass component may include 0.1% by mole to 25% by mole of bismuth oxide (Bi₂O₃); 10% by mole to 30% by mole of zinc oxide (ZnO); and 0.1% by mole to 25% by mole of titanium oxide (TiO₂). The glass component may also include one or more of tungsten oxide (WO₃), manganese oxide (MnO₂), antimony oxide (Sb₂O₃), and barium oxide (BaO) as far as the proportion of any one of these oxides is 0.1% or less by mole.

For example, screen printing is used to apply the base dielectric paste into a predetermined thickness onto rear glass substrate 21. The applied base dielectric paste covers address electrodes 22. Next, in a drying oven, the base dielectric paste is dried at a temperature ranging, for example, from 100° C. to 250° C. By the drying, the solvent is removed from the base dielectric paste. Lastly, in a baking oven, the base dielectric paste is baked at about 570° C. to about 630° C. In this way, the resin is removed from the base dielectric paste. Additionally, the glass component is melted. The melted glass component is again vitrified after the baking. However, the filler is not melted even by the baking. In other words, the melted glass component has a structure wherein the filler is dispersed in the glass component. The film thickness of base dielectric layer 23 is from 8 μm to 15 μm after the baking step. The film thickness of base dielectric layer 23 is measured by means of, for example, a reflection spectroscopic thickness meter (MCPD 3700, manufactured by Otsuka Electronics Co., Ltd.).

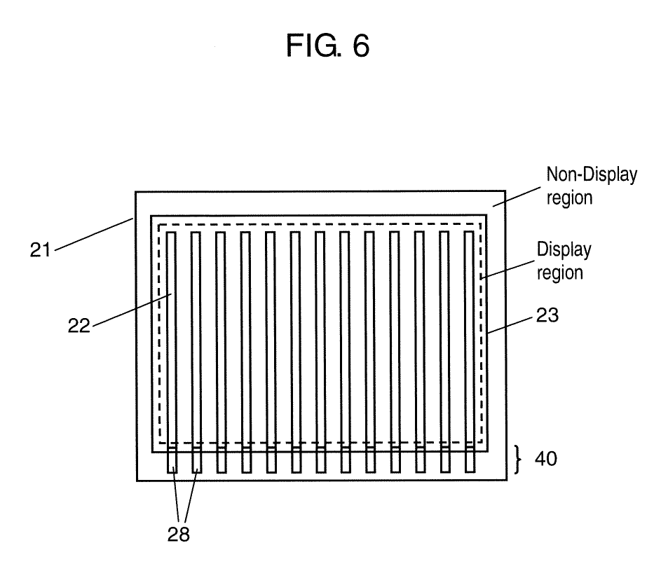

Through these steps, base dielectric layer 23 is formed. As illustrated in FIG. 6, base dielectric layer 23 covers the display region and a portion of terminal area 40. Besides the screen printing, spin coating or die coating, or some other manner may be used.

Next, photolithography is used to form barrier ribs 14. The material of barrier ribs 14 may be a barrier rib paste containing a filler, a glass frit for bonding pieces of the filler to each other, a photosensitive resin, a solvent and others. The proportion of the glass frit in the total of the glass frit and the filler is from 80% by weight to 85% by weight inclusive.

First, die coating or another coating method is used to apply the barrier rib paste into a predetermined thickness onto base dielectric layer 23. Next, in a drying oven, the barrier rib paste is dried at a temperature ranging, for example, from 100° C. to 250° C. By the drying, the solvent is removed from the barrier rib paste. Next, the barrier rib paste is exposed to light through a photomask having, for example, a lattice-form pattern. Next, the barrier rib paste is developed. When the used photosensitive resin is of a positive type, the exposed regions are removed. The remnant of the barrier rib paste is a barrier rib pattern. Lastly, in a baking oven, the barrier rib pattern is baked at a temperature ranging, for example, from 500 to 600° C. By the baking, the photosensitive resin is removed from the barrier rib pattern. By the baking, the glass frit in the barrier rib pattern is melted. However, the filler is not melted even by the baking. The melted glass frit is again turned to the glass component after the baking. In short, the barrier ribs 14 have a structure wherein the filler is dispersed in the glass component. Through these steps, barrier ribs 14 are formed. Besides the photolithography, a sandblasting manner or some other manner may be used. In the present embodiment, the average height of longitudinal barrier ribs 24a is about 120 μm. The average height is the average value of the respective heights of longitudinal barrier ribs 24a that are measured in plural regions of rear plate 20. The heights of the barrier ribs are measured by means of, for example, a laser displacement meter. When rear plate 20 and front plate 10 are fabricated into a unit, about 10 mm is the distance from the long side edges of front plate 10 to the outermost barrier rib 24.

Next, phosphor layer 25 is formed on base dielectric layer 23 and side surfaces of barrier ribs 24. The material of phosphor layer 15 may be a phosphor paste containing phosphor particles, a binder, a solvent and others.

For example, a dispersing manner is used to apply the phosphor paste into a predetermined thickness onto a base dielectric layer 23 between any adjacent two barrier ribs 24, and onto the side surfaces of barrier ribs 24. Next, in a drying oven, the solvent is removed from the phosphor paste. Lastly, in a baking oven, the phosphor paste is baked at a predetermined temperature. In short, the resin is removed from the phosphor paste. Through these steps, phosphor layer 25 is formed. Besides the dispensing manner, screen printing, or some other manner may be used.

Through these steps, rear plate 20 is finished, which has the predetermined constituting members on rear glass substrate 21.

Next, in sealing paste applying step B2, a sealing paste containing a sealing material is applied onto the non-display region of rear plate 20. The sealing paste contains a glass component, a filler, a solvent, an organic binder component, and bead members 30.

The solvent may be a solvent slightly soluble in water, such as α-terpineol, or butyl carbitol. The solvent may be a solvent that is freely mixable with water, such as a polyhydric alcohol derivative, examples thereof including ethylene glycol, ethylene glycol monoacetate, ethylene glycol monoethyl ether, ethylene glycol monobutyl ether, ethylene glycol monomethyl ether, ethylene glycol monomethyl ether acetate, 3-methoxy-3-methylbutanol, allyl alcohol, isopropyl alcohol, ethanol, glycidol, tetrahydrofurfuryl alcohol, t-butanol, furfuryl alcohol, propargyl alcohol, 1-propanol, methanol, 3-methyl-1-butyne-3-ol, 15-crown-5,18-crown-6, propylene oxide, 1,4-dioxane, dipropyl ether, dimethyl ether, tetrahydrofuran, acetoaldehyde, diacetone alcohol, methyl lactate, γ-butyrolactone, glycerin, glycerin 1,2-dimethyl ether, glycerin 1,3-dimethyl ether, glycerin 1-acetate, 2-chloro-1,3-propanediol, 3-chloro-1,2-propanediol, diethylene glycol, diethylene glycol ethyl methyl ether, diethylene glycol chlorohydrin, diethylene glycol diacetate, diethylene glycol diethyl ether, diethylene glycol dimethyl ether, diethylene glycol monoethyl ether, dipropylene glycol, dipropylene glycol monomethyl ether, and triethylene glycol.

The organic binder may be a compound having an average molecular weight of 30000 to 200000, such as hydroxylpropylcellulose, hydroxyethylcellulose, ethylhydroxyethylcellulose, carboxymethylcellulose, polyvinyl alcohol, polyvinyl ether, ethyl cellulose, or acrylic resin. PMA (propylene glycol monoethyl ether acetate), PVA (polyvinyl alcohol), or some other polymer may be added to the paste.

If necessary, one or more of the following plasticizers may be added thereto: dimethyl phthalate, diethyl phthalate, dibutyl phthalate, diheptyl phthalate, di-n-octyl phthalate, di-2-ethylhexyl phthalate, octyldecyl phthalate, diisodecyl phthalate, butylbenzyl phthalate, butyl oleate, diethylene glycol dibenzoate, butylphthalylbutyl glycolate, tributyl acetylcitrate, methyl abietate, dibutyl sebacate, 2-ethylhexyne sebacate, 2-nitrobiphenyl, dinonylnaphthalene, and di-2-ethylhexyl azelate.

The sealing paste may be obtained by mixing the above-mentioned materials with each other, and then dispersing the solid component(s) into the liquid. The method therefor may be specifically a method of mixing the materials, using a mixer that may be of various types, such as a ball mill, a blender mill, or a three-roll unit.

The glass component includes, for example, 20% by mole to 50% by mole of bismuth oxide (Bi₂O₃); 20% by mole to 40% by mole of zinc oxide (ZnO); 10% by mole to 30% by mole of boron oxide (B₂O₃); and 0.5% by mole to 2.5% by mole of aluminum oxide (Al₂O₃). The glass component also includes molybdenum oxide (MoO₃) or tungsten oxide (WO₃).

The filler adjusts the thermal expansion coefficient of sealing member 31. The filler also controls the fluid state of the glass. The filler may be, for example, cordierite, forsterite, β-eucryptite, zircon, mullite, barium titanate, aluminum titanate, titanium oxide, molybdenum oxide, tin oxide, aluminum oxide, or quartz glass.

Bead members 30 may be, for example, spherical glass bead members made of boron oxide (B₂O₃), aluminum oxide (Al₂O₃), or some other material. When bead members 30 are applied to, for example, PDP 100 having a size of a diagonal line length of 42 inches, the average particle diameter of bead members 30 is preferably from 110 μm to 180 μm. The average particle diameter denotes the volume cumulative average diameter (D50). The average particle diameter is measured by means of, for example, a laser diffraction type particle size distribution meter MT-3300 (manufactured by Nikkiso Co., Ltd.). The standard deviation of bead members 30 is about 5 μm. About the average particle diameter of bead members 30, it is preferred that the lower limit is a value 5 μm smaller than the height of barrier ribs 24, and the upper limit is a value 30 μm larger than the height of barrier ribs 24 since this case makes it possible to decrease a bend of front plate 10 and rear plate 20 of PDP 100 to reduce noise caused by the contact of front plate 10 with barrier ribs 24. The thickness of front glass substrate 11 ranges preferably from 1.0 mm to 3.0 mm. The thickness of rear glass substrate 21 ranges preferably from 1.0 mm to 3.0 mm.

As will be detailed later, the discharge space of PDP 100 is sealed up in the state that the pressure therein is reduced. Thus, it may occur that front plate 10 and rear plate 20 are bent so that front plate 10 contacts barrier ribs 24. When the bent region of front plate 10 contacts barrier ribs 24, noise may be generated by vibration or the like at the time of the operation of PDP 100. However, according to the above-mentioned structure, noise resulting from the contact of front plate 10 with barrier ribs 24 are decreased. In the present embodiment, the average particle diameter of bead members 30 is 130 μm.

Bead members 30 have an effect of keeping the interval between front plate 10 and rear plate 20 into a specified range. Bead members 30 do not deform at any temperature in the sealing step, which will be detailed later. The proportion by weight of bead members 30 in the glass component is preferably from 0.1% by weight to 2.0% by weight inclusive. If the proportion of bead members 30 is more than 2.0% by weight, the generation rate of disconnection is raised in address-electrode-side interconnect portions 28.

If the proportion of bead members 30 is less than 0.1% by weight, generated noise is increased when PDP 100 is being switched on. Specifically, if the proportion of bead members 30 is less than 0.1% by weight, the interval between front plate 10 and rear plate 20 falls below the value designed in many portions (of the interval-forming region). In other words, deformed portions of the periphery of PDP 100 are increased. By strain of the deformed portions, noise is increased.

When the proportion by weight of bead members 30 in the glass component is from 0.1% by weight to 2.0% by weight inclusive, the generation of disconnection is restrained in address-electrode-side interconnect portions 28. Furthermore, when PDP 100 is working, noise is restrained.

For the application of the sealing paste, use may be made of, for example, a screen printing, dispersing or ink-jetting manner. The dispersing manner is a manner of causing the sealing paste to spout from one or more spouting nozzles that a mouthpiece has. The dispensing manner is higher in the utilization efficiency of the paste material than screen printing and other manners.

In the screen printing manner, the sealing paste is present in an open system. Thus, it is necessary to consider effects based on the volatilization of the organic components (not shown), or on some other component.

In the dispensing manner, the sealing paste is present in a close system. Thus, the manner is characterized in that the viscosity of the sealing paste is scarcely changed so that the quantity of the application is constant and stable. It is desired to apply the sealing paste to adjust the width to about 4 mm and the height of the sealing paste about 350 μm, respectively, after the application.

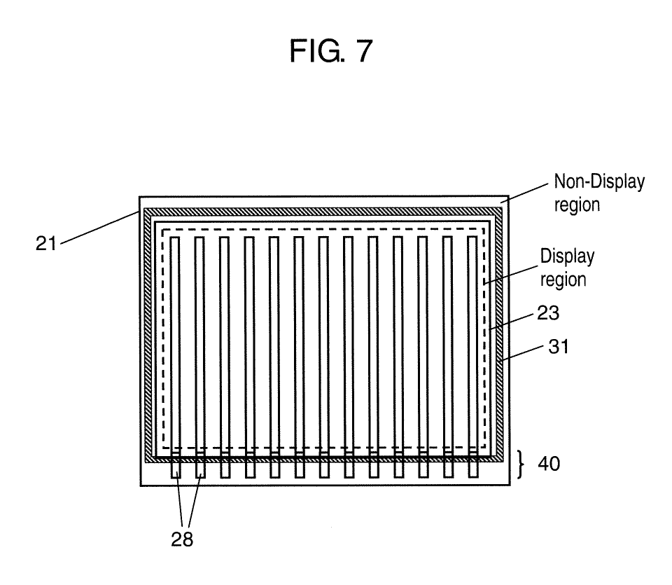

The applied sealing paste is pre-baked at a temperature of about 400° C. to be turned to sealing member 31. In other words, the solvent components and others are removed so that the pre-baked paste is kept to have a predetermined shape. As illustrated in FIG. 7, sealing member 31 is formed in the non-display region to surround the display region. Furthermore, sealing member 31 covers a base dielectric layer 23 edge laid on terminal area 40.

It is preferred that sealing member 31 is formed in an area extending in the extending direction of the address electrodes 22 outward, over distances from 0.5 mm to 1.5 mm inclusive, from an edge of a region where front plate 10 and rear plate 20 are to overlap. As will be detailed later, when sealing member 31 is melted, the discharge space is reduced in pressure. Thus, sealing member 31 is drawn toward the inside of the discharge space. For this reason, sealing layer 27 of PDP 100 completed is formed in an area extending outward within about 1 mm of the edge of the region where front plate 10 overlaps with rear plate 20. When sealing layer 27 is formed in this range, restrained is the generation of inconveniences, such as a poor contact between address-electrode-side interconnect portions 28 and the circuit board, because uncovered areas of address-electrode-side interconnect portions 28 become larger. In the present embodiment, it has been verified that when the pressure of the discharge space is reduced into the atmospheric pressure or less in the sealing step, sealing member 31 is drawn, by about 0.5 mm, to the inside of the discharge space. For this reason, by adopting the above-mentioned structure, sealing layer 27 is caused to remain outside front plate 10 even when sealing member 31 is drawn.

Front plate 10 and rear plate 20 are arranged to be opposed to each other. Next, peripheries of front plate 10 and rear plate 20 are sealed by using sealing member 31. Thereafter, discharge gas is put into the discharge space.

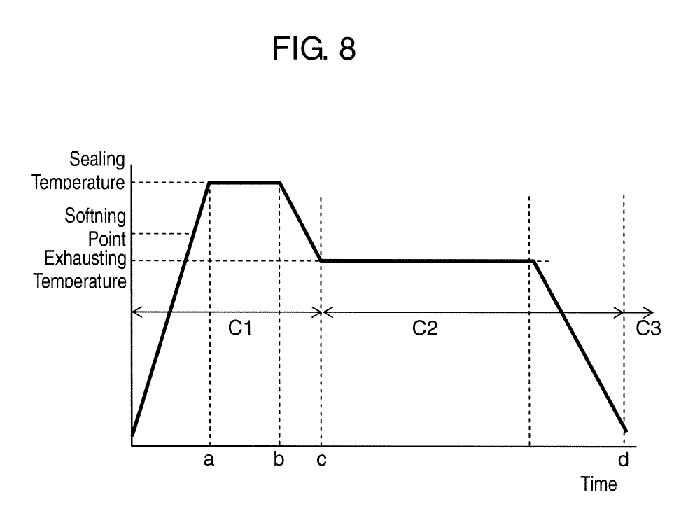

Sealing step C1, exhausting step C2, and discharge gas supplying step C3 according to the present embodiment are attained in the same equipment in accordance with a temperature profile illustrated in FIG. 8.

In FIG. 8, the wording “SEALING TEMPERATURE” represents the temperature of the system at the time of sealing front plate 10 and rear plate 20 to each other, for space-sealing, through sealing member 31. The sealing temperature in the present embodiment is, for example, about 420° C. The word “SOFTENING POINT” represents the temperature of the system at which the glass component is softened. In the embodiment, the softening point is, for example, about 380° C. The wording “EXHAUSTING TEMPERATURE” represents the temperature of the system when the atmosphere and others contained in the discharge space are exhausted from the discharge space. In the embodiment, the exhausting temperature is, for example, about 300° C.

First, in sealing step C1, the temperature of the system is raised from room temperature to the bonding temperature. By the temperature raise, the organic binder remaining the sealing member 31 is removed. Next, over period a-b, the temperature of the system is maintained to be the bonding temperature. By the maintenance, the glass component is softened. In other words, sealing member 31 formed by the pre-baking falls down into a flat form between front plate 10 and rear plate 20 so that sealing layer 27 is formed. Subsequently, the temperature is further lowered from the bonding temperature to the exhausting temperature in period b-c. In period b-c, the gas(es) inside the discharge space is/are discharged until a time when the pressure therein turns to about 1×10⁻⁴ Pa. In short, the inside of the discharge space is turned into a pressure-reduced state.

Thereafter, in exhausting step C2, the temperature is maintained to be the exhausting temperature over a predetermined period. The exhausting from the discharge space is continued. Thereafter, the temperature is lowered to room temperature or thereabout.

In a final step, i.e., in discharge gas supplying step C3, a discharge gas is introduced into the discharge space. Specifically, over a period after time d, at which the temperature has been lowered to room temperature or thereabout, the discharge gas is gas-tightly put thereinto to give a pressure of about 60 kPa. Lastly, the exhausting pipe (not shown), which is not illustrated, is stopped. Through this process, PDP 100 is completed.

When sealing member 31 is shrunken in sealing step C1 and exhausting step C2, bead members 30 contained in sealing member 31 are pressed between front plate 10 and rear plate 20. Thus, bead members 30 presses address-electrode-side interconnect portions 28 so that the portions may be cracked or undergo disconnection.

It is conceivable that sealing member 31 is laid on base dielectric layer 23 in order to restrain disconnection in address-electrode-side interconnect portions 28. However, in a case where the gas-tightness of base dielectric layer 23 is low, that is, base dielectric layer 23 has many voids, the gas-tightness of the discharge space may deteriorate when base dielectric layer 23 is exposed to the outside of the discharge space.

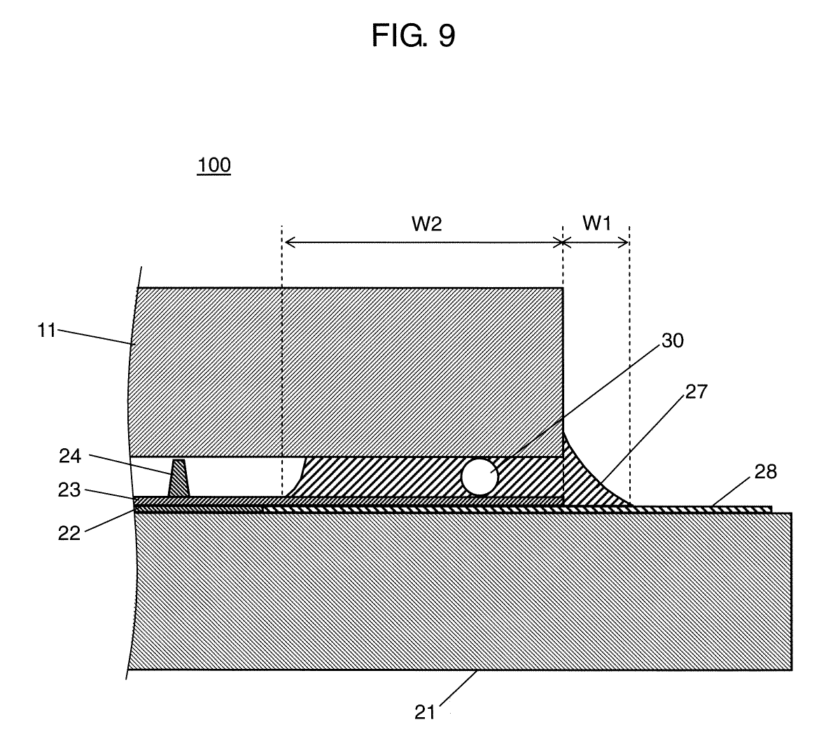

The following will describe details of sealing layer 27 in the present embodiment. As illustrated in FIG. 9, sealing layer 27 is formed in an area extending in the extending direction of address electrodes 22 over a length of about 0.5 mm outward from the address-electrode-side interconnect portion 28 side edge of base dielectric layer 23. In other words, the width W1 of the outside of sealing layer 27 from one of the (two) long-side edges of front plate 10 is about 0.5 mm in the extending direction of address electrodes 22. In this manner, sealing layer 27 is formed outside of the edges of the region where front plate 10 overlaps with rear plate 20. Thus, base dielectric layer 23 is restrained from being made uncovered. The width W1 of the outside of sealing layer 27 from the long-side edge of front plate 10 is preferably 1 mm or less in the direction of the short sides of front plate 10. This is because the uncovered areas of address-electrode-side interconnect portions 28 are made larger to restrain the generation of inconveniences, such as a poor contact between address-electrode-side interconnect portions 28 and the circuit board.

As illustrated in FIG. 9, it is further preferred that sealing layer 27 covers the (one) long-side edge of front plate 10 since a decline in the gas-tightness of the discharge space is further restrained, and further address electrodes 22 are restrained from being corroded.

When sealing member 31 is drawn in, a depression may be made in sealing layer 27 for sealing front plate 10 and rear plate 20. When water for washing enters the depression, address-electrode-side interconnect portions 28 and/or address electrodes 22 may be corroded. Furthermore, corroded address-electrode-side interconnect portions 28 and/or address electrodes 22 may be disconnected. However, in the present embodiment, the long-side edge of front plate 10 is covered so that the formation of any depression is restrained. Thus, address-electrode-side interconnect portions 28 and/or address electrodes 22 are restrained from being corroded. The edge of front plate 10 is covered by effect of surface tension of softened sealing member 31. As a result, the edge of front plate 10 is covered with sealing layer 27.

As illustrated in FIG. 9, it is preferred that about sealing layer 27, its area formed inward from the edge of front plate 10, where address electrodes 22 are extended and address-electrode-side interconnect portions 28 are located, is an area extending over distances of from 2 mm to 9 mm inclusive from the (one) long-side edge of front plate 10 in the long-side direction of front plate 10. In other words, it is preferred that the width W2 of a region of sealing layer 27 that is a region present inward from the edge of front plate 10 is from 2 to 9 mm inclusive. In this case, the drawing of sealing/bonding member 31 softened in bonding step C1 into the discharge space is further restrained. When the drawing of sealing member 31 is restrained, the exposure of base dielectric layer 23 to the outside is further restrained. Thus, a decline in the gas-tightness of the discharge space is further restrained. In the present embodiment, the width W2 is about 5 mm.

As illustrated in FIGS. 2, 7 and 9, in PDP 100 according to the embodiment, the area where base dielectric layer 23 is formed is located up to substantially the same position as one of the long-side edges of front plate 10 that are present when front plate 10 and rear plate 20 are arranged to be opposed to each other. In other words, even when bead members 30 are present between front plate 10 and address-electrode-side interconnect portions 28, base dielectric layer 23 is present between bead members 30 and address-electrode-side interconnect portions 28. Moreover, sealing layer 27 covers one of the edges of base dielectric layer 23. By adopting this structure, bead members 30 sandwiched between front plate 10 and rear plate 20 do not directly contact address-electrode-side interconnect portions 28. Additionally, base dielectric layer 23 is not exposed to the outside of PDP 100. Thus, a decline in the gas-tightness of the discharge space is restrained. Accordingly, in PDP 100 of the embodiment, a decline in the gas-tightness of the discharge space can be restrained while the disconnection of address-electrode-side interconnect portions 28 is prevented.

In the embodiment, a case where the measure against the disconnection of address-electrode-side interconnect portions 28 is taken has been described. The same advantageous effect is obtained also in a case where the above-mentioned technique is applied to display electrodes 14.

About base dielectric layer 23 in the embodiment, its edge at the address-electrode-side interconnect portion 28 side is formed to be present at substantially the same position where the (one) long-side edge of the region where front plate 10 overlaps with rear plate 20 is present. In other words, base dielectric layer 23 is formed in such a manner that the address-electrode-side interconnect portion 28 side edge of base dielectric layer 23 is opposed to the long-side edge of front plate 10. By adopting this structure, bead members 30 are prevented from contacting address-electrode-side interconnect portions 28 directly between front plate and address electrodes 22. Thus, the disconnection of address-electrode-side interconnect portions 28 is restrained.

The wording “substantially the same position” denotes any position in a range extending inward in the extending direction of address electrodes 22, from the address-electrode-side interconnect portion 28 side edge of the region where front plate 10 overlaps with rear plate 20, over a length substantially equal to the average particle diameter of bead members 30. The wording also denotes any position in a range extending outward in the extending direction of address electrodes 22, from the address-electrode-side interconnect portion 28 side edge of the region where front plate 10 overlaps with rear plate 20, over a length of about 0.5 mm. If one of the edges of base dielectric layer 23 is formed inward, by more than the average particle diameter of bead members 30, from the (address-electrode-side interconnect portion 28 side) edge of the region where front plate 10 overlaps with rear plate 20, bead members 30 may unfavorably contact address electrodes 22 directly between front plate 10 and address electrodes 22. If the edge of base dielectric layer 23 is formed outward, by a length of 0.5 mm or more, from the (address-electrode-side interconnect portion 28 side) edge of the region where front plate 10 overlaps with rear plate 20, base dielectric layer 23 is made uncovered so that the gas-tightness of the discharge space may be unfavorably declined.

As described above, PDP 100 of the embodiment has front plate 10, rear plate 20, and sealing layer 27 for bonding front plate 10 and rear plate 20. Rear plate 20 has the display region for generating electric discharge between rear plate 20 and front plate 10, and the non-display region arranged around the display region. Furthermore, rear plate 20 has terminal area 40 located in the non-display region, and base dielectric layer 23. Sealing layer 27 is laid in the non-display region, and has plural bead members 30. Base dielectric layer 23 covers the display region and a portion of terminal area 40, without sticking out from any outside region of sealing layer 27. Sealing layer 27 is partially located between a region of base dielectric layer 23 that covers terminal area 40, and front plate 10. Additionally, an edge of the region of base dielectric layer 23 that covers terminal area 40 is covered with sealing layer 27, and the edge lies at substantially the same position as an edge of front plate 10.

Sealing layer 27 laid on terminal area 40 may stick out from the edge of front plate 10, and the width (W1) of the sticking portion of the layer is preferably 1 mm or less.

In this manner, restrained is the generation of inconveniences, such as a poor contact between address-electrode-side interconnect portions 28 and the circuit board.

When barrier ribs 24 have an average height of 100 μm to 150 μm inclusive, it is preferred that the average particle diameter of bead members 30 has a lower limit 5 μm smaller than the average height of barrier ribs 24, and an upper limit 30 μm larger than the average height of barrier ribs 24. In this manner, noise caused by the contact between front plate 10 and barrier ribs 24 are decreased.

What is claimed is:

1. A plasma display panel, comprising:
a front plate;
a rear plate; and
a sealing layer for sealing the front plate and the rear plate,
wherein the rear plate has a display region for generating electric discharge between the rear plate and the front plate, and a non-display region arranged around the display region,
the rear plate further has a terminal area located in the non-display region, and a base dielectric layer,
the sealing layer is laid in the non-display region, and has plural bead members,
the base dielectric layer covers the display region and a portion of the terminal area without sticking outward from the sealing layer,
the sealing layer is partially located between a region of the base dielectric layer that covers the terminal area, and the front plate, and
an edge of the region of the base dielectric layer that covers the terminal area is covered with the sealing layer, and the edge lies at substantially the same position as an edge of the front plate.

2. The plasma display panel according to claim 1, wherein the bonding layer laid on the terminal area sticks out from the edge of the front plate, and the width of the sticking portion of the layer is 1 mm or less.

3. The plasma display panel according to claim 1, wherein the rear plate further has barrier ribs over the base dielectric layer,
the barrier ribs have an average height of 100 μm to 150 μm inclusive, and
an average particle diameter of the bead members has a lower limit 5 μm smaller than the average height of the barrier ribs, and
an upper limit 30 μm larger than the average height of the barrier ribs.

4. The plasma display panel according to claim 2, wherein the rear plate further has barrier ribs over the base dielectric layer,
the barrier ribs have an average height of 100 μm to 150 μm inclusive, and
an average particle diameter of the bead members has a lower limit 5 μm smaller than the average height of the barrier ribs, and an upper limit 30 μm larger than the average height of the barrier ribs.
